(19) United States
(12) Patent Application Publication
(10) Pub. No.: US 2009/0101066 A1
(43) Pub. Date: Apr. 23, 2009

(54) RACK USED TO FIX WORKPIECES

(75) Inventors: JIANG-RONG DING, Shenzhen (CN); JI-KAI LIU, Shenzhen (CN); JIA-CAI LUO, Shenzhen (CN); CHA-SONG XIE, Shenzhen (CN)

Correspondence Address: PCE INDUSTRY, INC.;ATT. Steven Reiss, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/964,852

(22) Filed: Dec. 27, 2007

(30) Foreign Application Priority Data
Oct. 19, 2007 (CN) 200710202169.5

(51) Int. Cl. B05C 3/00

(52) U.S. Cl. 118/428

(57) ABSTRACT

A rack (300) configured for holding workpieces (50) includes a base unit (30) and a cover unit (40). The base unit includes a plurality of holding members (31). Each holding member includes two parallel holding boards (311, 313) cooperating with each other to hold the workpieces, each holding board defines a plurality of gaps (312, 314) corresponding to the workpieces therein. The cover unit covers on the base unit.

### BACKGROUND OF THE INVENTION

1. Field of the Invention

The present invention relates to racks, particularly to a rack used to fix workpieces during ultrasonic washing.

2. Description of Related Art

Ultrasonic washing is widely used to clean many kinds of workpieces. During washing, the workpieces are fixed on racks and the racks are placed into a washing liquid. The washing liquid is then vibrated ultrasonically and the workpieces are cleaned by the vibration of the washing liquid.

Referring to FIG. 1 and FIG. 2, a typical rack 100 includes a frame 1 and a plurality of retainers 2 fixed on the frame 1. Each retainer 2 includes two opposite flexuous first arms 21 and a flexuous second arm 22 installed below, but in front of, the first arms 21. Each first arm 21 and second arm 22 zigzags, thus forming a plurality of first V-shaped portions 211 on each first arm 21 and a plurality of second V-shaped portions 221 on the second arm 22. The apex of the V's, of each first V-shaped portions 211 and each second V-shaped portions 221, align with each other. One second V-shaped portion 221 cooperates with two corresponding first V-shaped portions 211 to define a fixing space (not labeled). Thus a workpiece 3 can be fixed in the fixing space. In this way, the typical rack 100 can accommodate a plurality of workpieces 3.

However, some workpieces, such as a housing of a mobile phone, generally, includes a polished portion formed on at least one of its both sides. When the workpiece is being placed on the rack 100, the polished portion comes into contact with the first arms 21 and the second arm 22. Thus, the polished portion may be scratched by the first arms 21 and/or the second arm 22 when being mounted, removed, or during washing of the workpiece.

Therefore, an improved rack is desired in order to overcome the above-described shortcomings.

### SUMMARY

A rack configured for holding workpieces includes a base unit and a cover unit. The base unit includes a plurality of holding members. Each holding member includes two parallel holding boards cooperating with each other to hold the workpieces, each holding board defines a plurality of gaps corresponding to the workpieces therein. The cover unit covers on the base unit.

Other advantages and novel features will become more apparent from the following detailed description when taken in conjunction with the accompanying drawings.

### BRIEF DESCRIPTION OF THE DRAWINGS

Many aspects of the present rack can be better understood with reference to the following drawings. The components in the drawings are not necessarily drawn to scale, the emphasis instead being placed upon clearly illustrating the principles of the present rack. Moreover, in the drawings, like reference numerals designate corresponding parts through out the several views.

FIG. 1 is a schematic view of a typical rack.

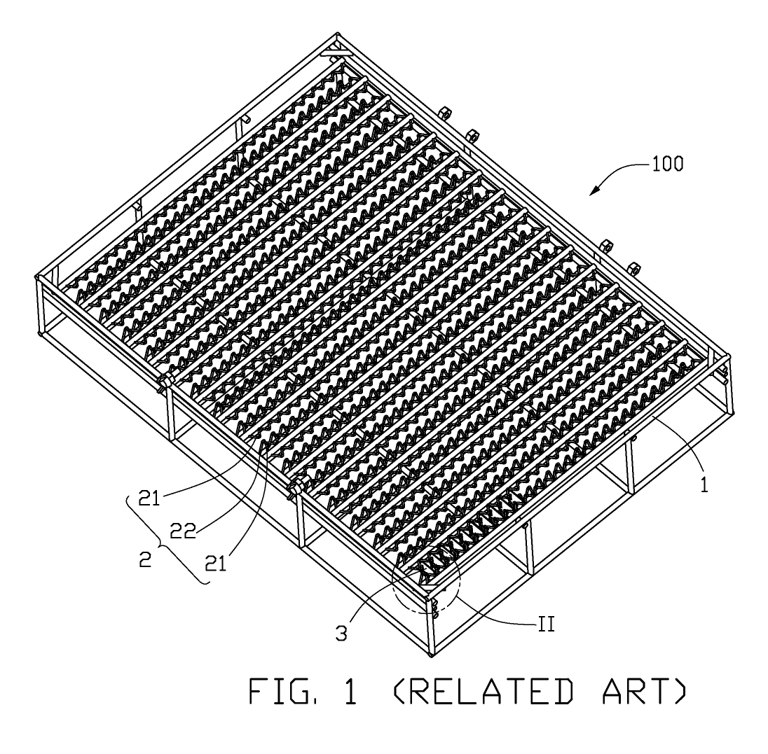

FIG. 2 is an enlarged view of the portion 11 shown in FIG. 1.

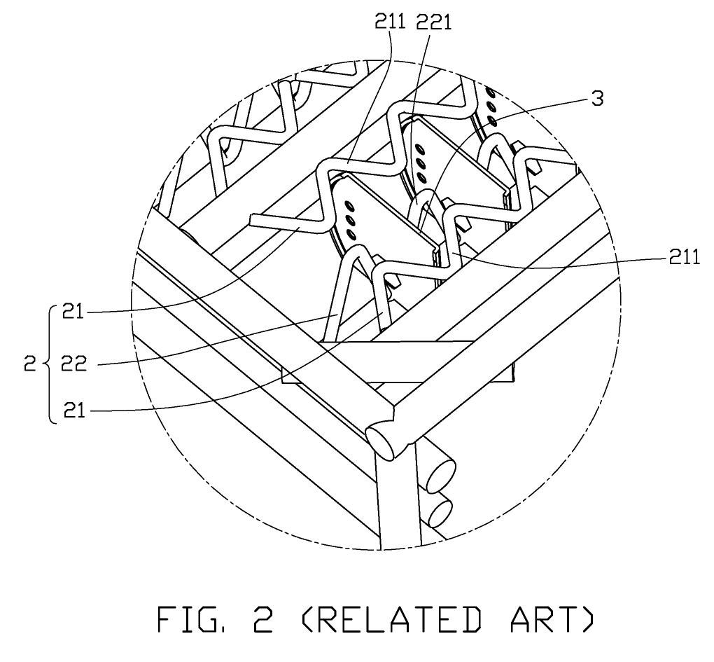

FIG. 3 is a disassembled view of a rack, in accordance with a present embodiment.

FIG. 4 is a schematic view of a plurality of workpieces fixed on the assembled rack shown in FIG. 3.

FIG. 5 is an enlarged view of the portion V shown in FIG. 4.

### DETAILED DESCRIPTION OF THE INVENTION

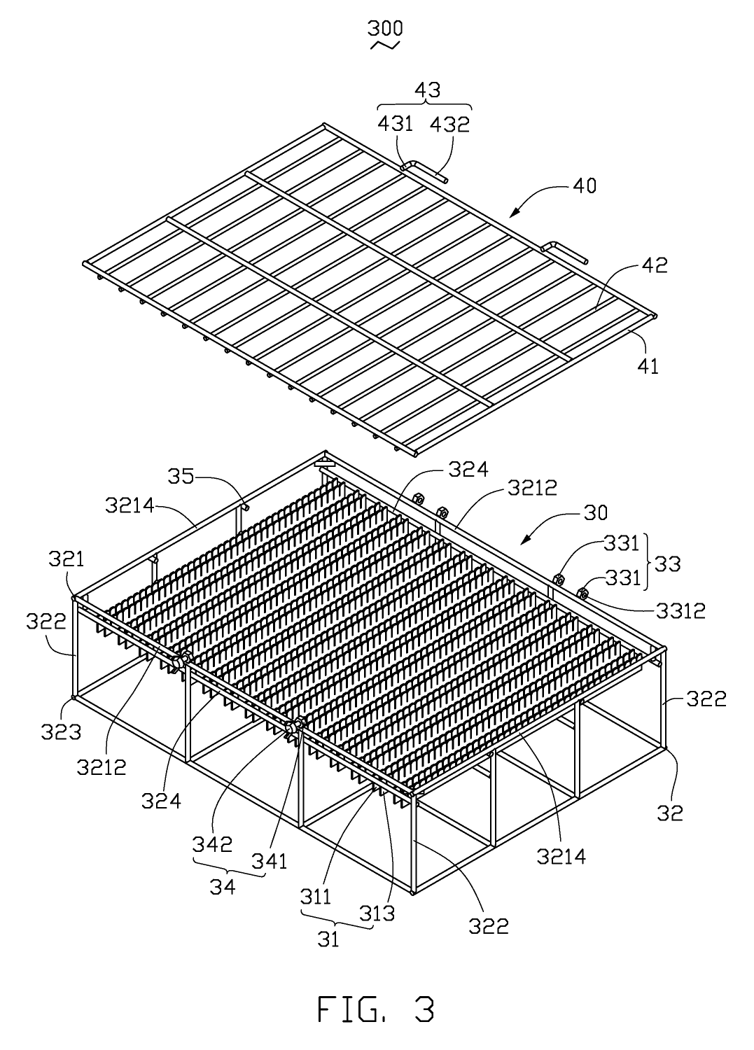

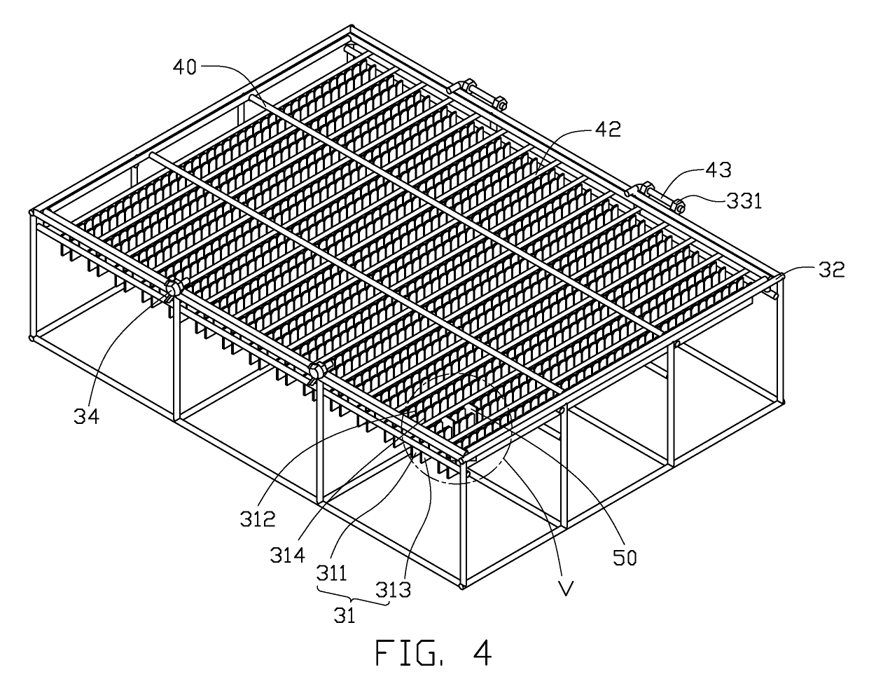

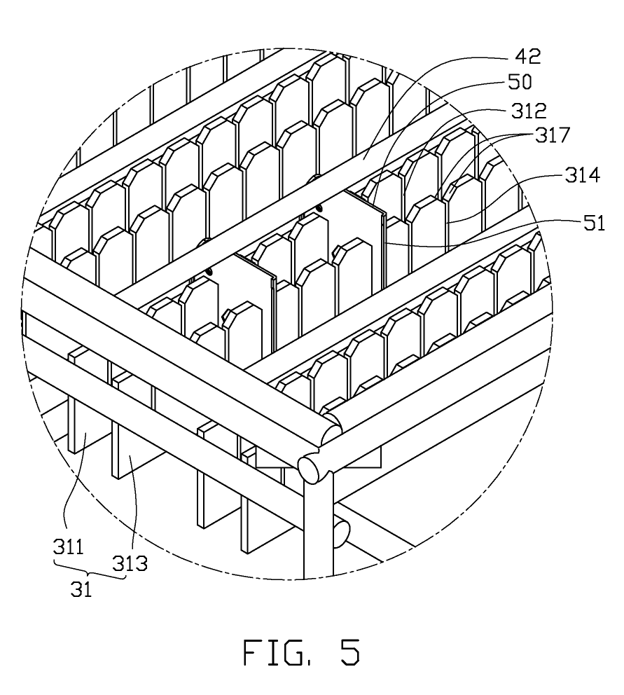

Referring to the drawings in detail, FIG. 3 shows a rack 300, in accordance with a present embodiment. The rack 300 includes a base unit 30 and a cover unit 40 covering the base unit 30. The base unit 30 includes a plurality of holding members 31 and a first frame member 32 configured to fix the holding members 31. Also referring to FIG. 4 and FIG. 5, each holding member 31 includes two parallel holding boards 311, 313. The holding boards 311 and 313 respectively define a plurality of equidistant gaps 312 and 314 therein.

The workpiece 50 is a housing shaped as a board, and two polished portions 51 are respectively formed on two opposite ends thereof. A distance between the two holding boards 311 and 313 of each holding member 31 is positioned to be less than a distance between two polished portions 51 of a workpiece 50. A width of each gap 312/314 is configured to be equal to a thickness of the workpiece 50, and a depth of each gap 312/314 is configured to be less than a length of the workpiece 50. In this way, the workpiece 50 can be conveniently fixed in and removed from the gap 312/314, without the polished portions 51 being scraped by the holding boards 311/313. Two corners of the holding board 311/313, which corresponds to each gap 312/314, can be cut to form a V-shaped section 317 to conveniently insert the workpieces 50 into the gaps 312/314.

The first frame member 32 includes a top frame 321, a bottom frame 323 opposite to the top frame 321 and a plurality of supporting poles 322 perpendicularly installed between the top frame 321 and the bottom frame 323. The top frame 321 includes two parallel first bars 3212 and two second bars 3214 perpendicular to the first bars 3212. Two latching members 33 are respectively fixed adjacent to two ends of one first bar 3212. Each latching member 33 includes two latching nuts 331 coaxially mounted on the first bar 3212, and each latching nut 331 defines a latching hole 3312 along its axis therein. One side of each latching nut 331 is attached to the first bar 3212, thus the axis of each latching component 331 is positioned to be parallel to the first bar 3212.

Two locking members 34 are mounted on another first bar 3212. Each locking member 34 includes a locking nut 341 and a bolt 342 corresponding to the locking nut 341. One side of the locking nut 341 is attached to the first bar 3212, and the axis of the locking nut 331 is positioned to be parallel to that of the first bar 3212. A plurality of protrusions 35 are mounted on each second bar 3214. One end of each protrusion 35 is fixed on a second bar 3214, and another end of the protrusion 35 extends parallel to the first bar 3212.

Two retaining poles 324 parallel to the first bars 3212 are fixed on the supporting poles 322. Two ends of each holding member 31 are respectively fixed to the two retaining poles 324. The holding members 31 are, advantageously, equidistantly mounted between the two retaining poles 324. Each gap 312/314 is positioned towards the top frame 321.

The cover unit 40 includes a rectangular second frame member 41 corresponding to the first frame member 32 and a plurality of parallel pressing poles 42 corresponding to the holding members 31 and fixed on the second frame member 41. Two L-shaped hinges 43 are fixed on a side (not labeled) of the second frame member 41, each hinge 43 includes a connecting pole 431 and a latching pole 432. One end of the connecting pole 431 is perpendicularly fixed to the side and perpendicularly connected to the latching pole 432, thus the latching pole 432 is positioned parallel to the side. A length of the latching pole 432 is longer than a distance between the two latching nuts 331 of each latching member 33. The pressing poles 42 are advantageously equidistantly fixed on the second frame member 41 corresponding to the holding members 31.

In assembly, the latching poles 432 are respectively inserted into the latching hole 3312 of the two latching members 33, thus the cover unit 40 is rotatably mounted on the base unit 30.

Also referring to FIG. 4 and FIG. 5, in use, a plurality of workpieces 50 are fixed on the rack 300. Each workpiece 50 is inserted into two corresponding gaps 312 and 314 of a holding member 31. The cover unit 40 is then closed and supported by the supporting protrusions 35. The bolts 342 are inserted into the locking nuts 341 and rotated, an end of each bolt 342 extends out of its corresponding locking nut 341, thus the cover unit 40 is held on the base unit 30. In this way, the workpieces 50 are fixed on the holding members 31 and pressed by the pressing poles 42 corresponding to the holding members 31, thus the rack 300 with the workpieces 50 can be placed into a washing liquid.

Understandably, since a distance between two holding boards 311 and 313 of each holding member 31 is less than a distance between two polished portions 51 of a workpiece 50, the polished portions 51 does not come into contact with the two sides of the holding member 31 when the workpiece 50 is inserted into the gaps 312 and 314. In this way, the polished portions 51 are prevented from being scratched by the holding member 31 and thus the quality of the workpieces 50 is maintained.

It is, however, understood that the gaps 312/314, the holding members 31 and the pressing poles 42 can also be arranged in some other configuration (i.e., non-equidistant spacing).

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A rack configured for holding workpieces, the rack comprising:
a base unit including a plurality of holding members, each holding member including two parallel holding boards cooperating with each other to hold the workpieces, each holding board defining a plurality of gaps corresponding to the workpieces therein; and
a cover unit covered on the base unit.

2. The rack as claimed in claim 1, wherein two corners of the holding board corresponding to each gap is cut to form a V-shaped section.

3. The rack as claimed in claim 1, wherein the base unit includes a first frame member, the holding members being mounted on the first frame member.

4. The rack as claimed in claim 3, wherein the first frame member includes a top frame, a bottom frame opposite to the top frame and a plurality of supporting poles perpendicularly installed between the top frame and the bottom frame.

5. The rack as claimed in claim 4, wherein the first frame member includes two retaining poles fixed on the supporting poles, the holding members being mounted between the two retaining poles, and each gap of the holding members being positioned towards the top frame.

6. The rack as claimed in claim 5, wherein two latching members are mounted on the top frame.

7. The rack as claimed in claim 6, wherein the cover unit includes two hinges corresponding to the latching members.

8. The rack as claimed in claim 7, wherein each latching member includes two latching nuts and its corresponding hinge includes a latching pole inserted into the two latching nuts, thus the cover unit being rotatably mounted on the base unit.

9. The rack as claimed in claim 3, wherein the cover unit includes a second frame member corresponding to the first frame member and a plurality of protrusions mounted on the second frame member.

10. The rack as claimed in claim 1, wherein the cover unit includes a plurality of pressing poles corresponding to the holding members.
